(19) United States
(12) Patent Application Publication
(10) Pub. No.: US 2022/0145572 A1
(43) Pub. Date: May 12, 2022

(54) Flat-Based Foundation

(71) Applicant: MAX BÖGL WIND AG, Sengenthal (DE)

(72) Inventor: Thorsten Betz, Neumarkt i.d. OPf. (DE)

(21) Appl. No.: 17/437,518

(22) PCT Filed: Mar. 4, 2020
(86) PCT No.: PCT/EP2020/055745

§ 371 Date: Sep. 9, 2021

(30) Foreign Application Priority Data
Mar. 19, 2019 (DE) 10 2019 106 972.6

(51) Int. Cl. E02D 27/42; E02D 27/01

(52) U.S. Cl. CPC E02D 27/42; E02D 27/01

(57) ABSTRACT

A flat-based foundation for a structural component includes a foundation plate having an underside, an upperside, and a center. At least one first soft layer insert is located on or underneath the underside of the foundation plate. The at least one first soft layer insert is a non-load-transferring layer and is arranged at a distance from the center so that the foundation plate is split into at least one inner load-transferring area and at least one outer load-transferring area.

### CROSS-REFERENCE TO RELATED APPLICATIONS

This application is a national stage of International Application No. PCT/EP2020/055745, filed Mar. 4, 2020, and claims benefit to German Patent Application No. 10 2019 106 972.6, filed Mar. 19, 2019, both of which are incorporated by reference herein.

### TECHNICAL FIELD

The present disclosure relates to a flat-based foundation for a structural component, especially for a projecting structure, particularly for a wind turbine tower, with a foundation plate having an underside, an upperside and a center. The foundation has at least one initial, not load-transferring soft layer insert on or underneath the underside of the foundation plate.

### BACKGROUND

Moment-loaded, flat-based foundations frequently have the problem that the subsoil is subject to a higher load in the peripheral areas of the foundation than in the middle area of the foundation. This can lead to a gaping of the ground joint between foundation and subsoil, and additionally also to a tilting of the foundation together with the structural component. An example of such structural components are poles with an eccentric load application such as utility poles or telecommunication towers. Likewise, the foundations of towers, especially of wind turbine towers with changing dynamic loads, are subject to considerable moment loads that have the consequences described above, which often also lead to the formation of a saddle area. As a result of this, the stability of the foundation with the structural component can be greatly affected. Other constructions with greater eccentric loads can also have these problems. Therefore, such foundations are generally executed with very large dimensions.

Moreover, for foundations of wind turbines it has also been already suggested to arrange a soft layer in the middle area of the foundation. This is described, for example, in the publication “Schäden an Tragstrukturen für Windenergieanlagen” [Damages to Support Structures for Wind Turbines] (Horst Bellmer, Fraunhofer IRB Verlag, 2016). As a result of this, the place where the force is introduced into the subsoil is brought to the outer areas of the foundation, which can counteract the formation of a saddle area. However, massive foundation bodies are still needed.

### SUMMARY

A task of the present disclosure is therefore to suggest a foundation capable of resisting gaping better.

The task is solved by a foundation having the features disclosed herein.

A flat-based foundation for a structural component, especially for a projecting structure, particularly for a wind turbine tower, has a foundation plate with an underside, an upperside, and a center. Furthermore, the foundation has on or under the underside of the foundation plate at least an initial, non-load-transferring soft layer insert. In such a foundation, it is now foreseen that the at least one initial soft layer insert is no longer arranged in the middle area as in the state of the art, but rather at a distance from the center. At the same time, the at least one initial soft layer insert is arranged at a distance from the center in such a way that it splits the foundation into at least one inner and at least one outer load-transferring area. The inner load-transferring area is thus closer situated to the center than the outer load-transferring area, which is situated farther away from the center.

The split into an outer and an inner load-transferring area makes it now possible to guide at least part of the occurring forces no longer all the way to the exterior and the peripheral areas of the foundation, but to the inner load-transferring area, where they can be directly transferred to the ground. Essentially, this is about the forces resulting from the normal force of the structural component and of the foundation, which can now be guided to the subsoil, at least in part directly to the middle area of the foundation. Likewise, only a part of the forces to be transferred, namely essentially the forces resulting from the moment load, are guided further all the way to the outer load-transferring area(s) and thus transferred to a peripheral area of the foundation.

As the forces are now guided to the peripheral areas of the foundation, a larger lever arm—which has a favorable influence on the frequently decisive proof of the gaping foundations—is the result. Consequently, these foundations can be less massive and built a lot smaller compared to the state of the art. Another advantage of such a soft layer insert arranged at a distance from the center is that it can be purposefully placed according to the static or dynamic loads that will occur later during the operation and can thus be adapted for every structural component or structure to be arranged on the foundation. As a result of this, even strongly one-sided eccentric loads can also be taken into account, for example.

According to an advantageous embodiment of the foundation, the at least one initial soft layer insert is arranged around the center in the shape of a ring, especially a circular or rectangular ring. Such an embodiment is particularly suitable for structural components or structures having changing eccentric loads from the most varied directions. For example, such loads occur in wind turbine towers in which both the wind forces and the loads caused by the rotating rotors coming from changing directions act upon the structure.

According to another embodiment of the disclosed subject matter, it is advantageous if the foundation has at least another not load-transferring soft layer insert on or under the underside of the foundation plate that is arranged at a radial distance to the at least one initial soft layer insert. The outer and the inner soft layer insert are thus spatially separated from one another. As a result of this, the foundation is split into several inner load-transferring areas and an outer load-transferring area, for example. In any case, by selectively arranging one or several soft layer inserts, it is possible to adjust the introduction of the forces acting upon the foundation to the subsoil in order to optimize the load-bearing capacity. Here, and also for the purposes of this entire patent application, the term radially refers not only to circular or circular ring-shaped foundations, but merely to the space from the center of the foundation to the exterior.

At the same time, it is once again advantageous if the at least one further soft layer insert is concentrically arranged inside the at least one initial soft layer insert. However, such a symmetrical execution is, as described above, appropriate for structural components or structures having changing loads coming from the most varied directions.

According to an initial embodiment of the foundation with an additional soft layer insert, it is advantageous if the at least one further soft layer insert is arranged in the form of a ring, especially of a circular or rectangular ring, around the center. As a result of this and in spite of the arrangement of two soft layer inserts, a larger, inner load-transferring area is nonetheless present.

According to another advantageous embodiment, the at least one further soft layer insert is executed as a soft layer core around the center. As in the state of the art, an advantageous deflection of the forces towards the outer areas of the foundation takes place, thereby counteracting the formation of a saddle area.

Moreover, especially in a circular- or rectangular foundation, it is also advantageous for the soft layer core if it is executed around the center in the form of a circle or rectangle.

According to advantageous embodiment of the foundation, a granular subbase is additionally arranged under the foundation plate of the foundation. Typically, it serves to provide a flat, clean surface for subsequent foundation work.

If the foundation has a granular subbase, then it is advantageous for the at least one initial and/or the at least one further soft layer insert to be arranged at least partially inside the granular subbase. However, as an alternative, it is also possible for the at least one initial and/or the at least one further soft layer insert to be arranged below the granular subbase. As a result of this, the subsequent foundation construction can be facilitated.

According to another embodiment, it is advantageous if the at least one initial and/or the at least one further soft layer insert to be arranged at least partially inside the foundation plate.

It is advantageous if the at least one initial and/or the at least one further soft layer insert is/are made of foam, especially of expanded polystyrene. Such materials are so soft that they cannot contribute to transfer the load to the subsoil and are therefore suitable to continue transferring the forces to the load-transferring areas of the foundation.

It is furthermore advantageous if the at least one initial soft layer insert is at a certain distance to a peripheral area of the foundation, which is between ⅓ and ½ of the distance of the center to the peripheral area. Thus, if the foundation has a circular design, the distance of the soft layer insert to the peripheral area is one-half to no more than one-third of the radius of the foundation.

Hence, the at least one initial soft layer insert is arranged about centrally, between the peripheral area and the center, so that a sufficiently large, other load-transferring area is still attained.

### BRIEF DESCRIPTION OF THE DRAWINGS

Further advantages of the disclosed subject matter are described in the following figures.

FIG. 1 is a schematic lateral view of a foundation with a structural component.

FIG. 2 is a schematic sectional view of a foundation with an initial soft layer insert.

FIG. 3 is a schematic sectional view of a foundation with an initial and a further soft layer insert.

FIGS. 4-7 are respective schematic bottom views of a foundation according to various embodiments.

FIG. 8 is a schematic sectional view of a foundation with an initial and a further soft layer insert and a granular subbase.

FIG. 9 is a schematic half-sectional view of a foundation with an initial soft layer insert for a spherical bearing.

### DETAILED DESCRIPTION

In the following description of the figures, the same reference signs are used for identical and/or at least comparable features. The individual features, their design and/or mode of action are explained in detail mostly when they are mentioned for the first time. If individual features are not explained in detail once again, then their design and/or mode of action correspond to the features having the same mode of action or name that were explained above. Moreover, for reasons having to do with the clarity of several identical features, frequently only one or a few are provided with reference signs and furthermore not all reference signs are shown in all figures either.

FIG. 1 shows a schematic lateral view of a foundation 1 with a structural component 2. Here, the foundation 1 contains a foundation plate 11 and has an underside 4, an upper side 5, a peripheral area 3, and a center MP. The center MP is located on a middle line shown as a dotted line and shown here at the height of the underside 5 of the foundation 1 or of the foundation plate 11. However, for the present disclosure, the height position of the center MP is unimportant. A structural component 2, which in this case is a structure projecting from the foundation such as tower or pole, has been arranged on the foundation 1. The structural component 2 has a specific own weight and is additionally exposed to various static and/or dynamic effects. Therefore, at the interface between the structural component 2 and the foundation 1, various loads are introduced into the foundation 1 and transferred from it to the subsoil. Here, these loads are symbolized in a very general way by a normal force N and a moment load M. The structural component 2 shown here could be, for example, a wind turbine tower carrying its own weight and the weight of the components arranged on it such as a nacelle, rotor and the like and is additionally exposed to changing dynamic loads caused by wind loads and the operation of the wind turbine. This is, however, to be understood only in an exemplary way. The presently disclosed subject matter is also appropriate for foundations 1 that are exposed only to a specific eccentric introduction of force or also to changing eccentric introductions of force.

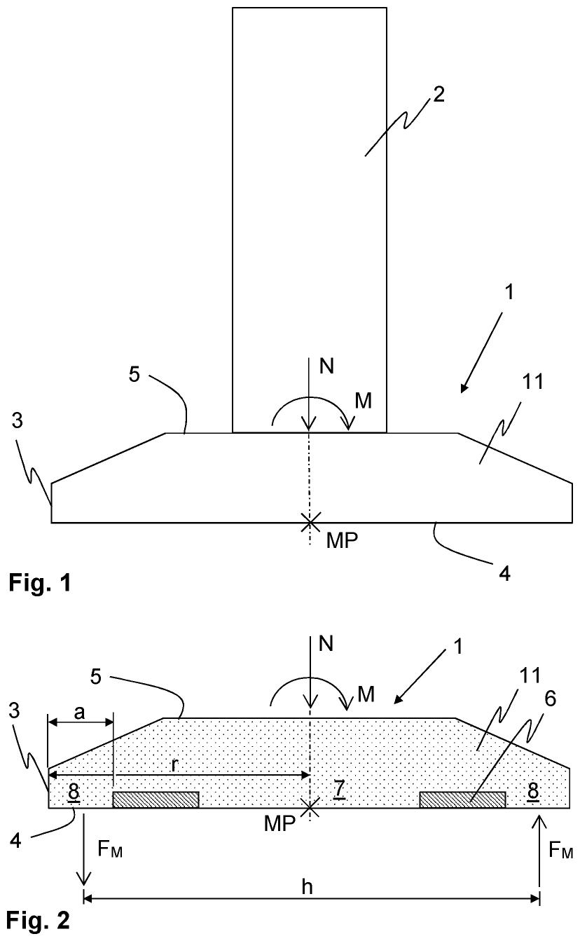

FIG. 2 shows a schematic sectional view of a foundation 1 with an initial soft layer insert 6. As can be seen in the figure, the soft layer insert 6 is not directly arranged around the center MP, but at a distance from it. As a result of this, an inner load-transferring area 7 and an outer load-transferring area 8 are formed in an area arranged in the middle area of the foundation 1, around the center MP. Here, the foundation 1 is designed in a circular shape, so that the initial soft layer insert 6 has correspondingly the form of a circular ring and developed like a soft layer ring, and an outer load-transferring area 8 shaped like a circular ring is also formed. The inner load-transferring area 7, on the other hand, is circular.

As can be seen in FIG. 2, the inner load-transferring area 7 makes it now possible to transfer the occurring normal force N essentially directly or at least near the point of introduction at the upperside 5 of the foundation 1 downward to the subsoil. Additional bending loads of the foundation 1, which can lead to the formation of cracks, can be thereby prevented. The pair of forces F_{M} resulting from the moment load M can, on the other hand, be advantageously transferred by the outer load-transferring area 8 near the peripheral area 3 of the foundation 1 as in the state of the art, wherein an advantageously large lever arm h or a distance between the two forces of the pair of forces F_{M} is present.

However, owing to the fact that the foundation 1 was split into an outer 8 and an inner load-transferring area 7, the forces F_{M} to be transferred in the outer load-transferring area 8 are overall lower, and the foundation 1 can now be built considerably smaller than in the state of the art. For example, a foundation 1 for a wind turbine tower can typically be built with a radius approx. 20% smaller than is the case with current circular foundations. As a result, significant savings in concrete and reinforcement material can be obtained, so that the foundations 1 can also be built much more economically. Naturally, these advantages apply not only to the foundation 1 shown in FIG. 2, but also to the foundations of the other embodiments.

The at least one initial soft layer insert 6 is arranged at a distance from the peripheral area 3 of the foundation 1, which is preferably between one third and one half of the distance r of the center MP to the peripheral area 3.

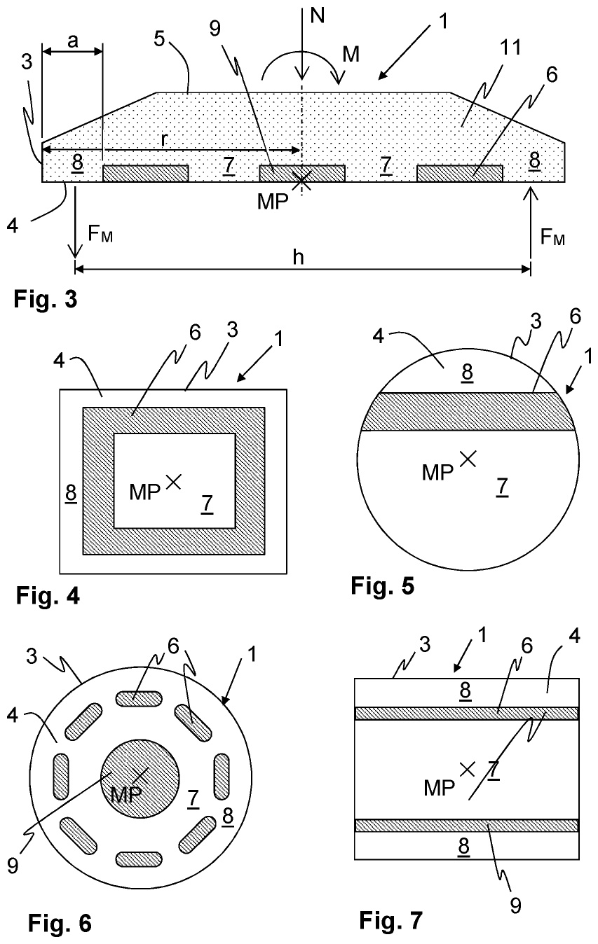

FIG. 3 shows an alternative embodiment of a foundation, in which in addition to the initial soft layer insert 6—here likewise in form of a soft layer ring—a further soft layer insert 9 is provided. Here, the further soft layer insert 9 is executed as a soft layer core surrounding the center. As a result of this, the inner load-transferring area 7 is executed in the shape of a circular ring around the soft layer core. The outer load-transferring area 8 is also executed in the shape of a circular ring, as described above. As the inner load-transferring area 7 is closer to the center MP than the outer load-transferring area 8, the advantages of a lower foundation load and the prevention of crack formation can also be attained with this embodiment as well. If the structural component 2 is a wind turbine tower, then the inner load-transferring area 7 can be basically placed directly underneath the tower wall lining, thereby allowing an especially favorable load transfer to take place.

Departing from the view shown, it would naturally also be conceivable to execute the further soft layer insert 9 not as a soft layer core but likewise ring-shaped around the center MP. In this case, two inner load-transferring areas 7 and an outer load-transferring area 8 are executed, wherein the described advantages can likewise be achieved.

Even if an essentially circular foundation 1 was described in FIGS. 2 and 3, the above-mentioned advantages can naturally also be achieved with foundations 1 having rectangular, polygonal or other forms.

FIG. 4 shows, for example, a bottom view of a foundation 1 having a basic rectangular form. Such a foundation 1 could be used for a pole such as a utility pole or a telecommunication tower, for example. In this case, the at least one initial soft layer insert 6 is executed in the form of a rectangular ring. Naturally, the arrangement of a further soft layer insert 9 (see FIG. 3) similar to the one in FIG. 3 is possible. The further soft layer insert 9 would in this case also have the form of either a rectangular ring or, provided the further soft layer insert 9 is executed as soft layer core, executed as a rectangle around the center.

However, regardless of the basic form of the foundation 1, it is by no means necessary to execute the at least one initial soft layer insert 6 and/or the at least one further soft layer insert 9 in the shape of a ring. Rather, the most varied forms and arrangements of soft layer inserts 6, 9 are possible depending on the occurring loads.

FIG. 5 shows, for example, a bottom view of a circular foundation 1 in which one initial soft layer insert 6 is arranged in form of a strip. As a result of this, the foundation 1 is split once again into an inner load-transferring area 7 arranged closer to the center MP and an outer load-transferring area 8 arranged farther from the center MP. For example, such an embodiment would be suitable for an exclusively one-sided eccentrically loaded structural component 2. The same advantages can naturally also be attained with a rectangular foundation 1 in a similar manner.

FIG. 6 shows another embodiment of a foundation with several initial soft layer inserts 6 and in this case a further soft layer insert 9. The several initial soft layer inserts 6 are arranged at such a distance to one another and the center MP that they—as similarly described in FIGS. 2 and 3—also form a soft layer ring as a whole. Naturally, with such an embodiment it could also be conceivable to dispense with a further soft layer insert 9. Moreover, it is naturally not necessary for the several initial soft layer inserts 6 to be arranged in a ring-shaped way. This figure should merely demonstrate that several initial soft layer inserts 6 can also be arranged in such a way that once again, the result is at least one inner load-transferring area 7 and one outer load-transferring area 8.

FIG. 7 shows a bottom view of another foundation 1 in which an initial soft layer insert 6 and a further soft layer insert 9 are arranged. Here, the soft layer inserts 6, 9 split the foundation 1 into an inner load-transferring area 7 and two outer load-transferring areas 8. Such an embodiment would then be advantageous, for example, if eccentric loads from two opposite directions alternately act upon the structural component 2 (not shown here). Needless to say, in this case it is not absolutely necessary for the two soft layer inserts in 6, 9 to have the same distance to the center MP.

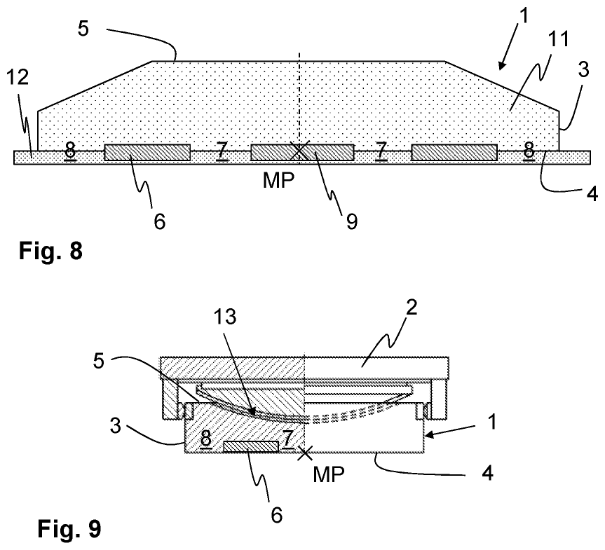

FIG. 8 shows additionally yet another schematic sectional view of a foundation 1 with an initial 6 and a further soft layer insert 9 plus a granular subbase 12. Here, the soft layer inserts 6, 9 are partially arranged inside the granular subbase 12 and thus also only partially arranged inside the foundation plate 11. Such an arrangement has the advantage that the protecting concrete layer around the reinforcement of the foundation body is not weakened. In addition, the assembly of the soft layer insert can take place independently from the foundation construction. If the soft layer insert is arranged in the foundation, then the granular subbase can once again be impinged with greater loads. Naturally, the embodiment of the foundation 1 and the arrangement of an initial 6 and also of a further soft layer insert 9, if need be, should merely be understood as exemplary. Both the form and size of the foundation 1 as well as the form, type and number of soft layer inserts 6, 9 do not play a role in the arrangement of the soft layer insert(s) 6, 9 in, above or below the granular subbase 12.

Finally, FIG. 9 shows one additional schematic half sectional view of a foundation 1 with an initial soft layer insert 6 for a spherical bearing 13. The structural component 2 is in this case formed by a bearing plate of the spherical bearing 13, while the foundation 1 forms the lower part of the spherical bearing 13. In such spherical bearings 13, high eccentric forces are introduced into the lower part of the spherical bearing 13 (or into the foundation 1 here) via the bearing plate. As already described for FIG. 1, through the at least one initial soft layer insert 6, which is arranged at a distance from the center MP, the normal forces N (not shown here) can largely be transferred to the subsoil through the inner load-transferring area 7 and the eccentrically introduced forces (not shown) through the outer load-transferring area 8.

The present disclosure is not limited to the embodiments shown and described. Deviations within the framework of the patent claims are just as possible as a combination of the features, even if they are shown and described in different embodiments.

### LIST OF REFERENCE NUMERALS

1 Foundation
2 Structural component
3 Peripheral area
4 Underside
5 Upperside
6 Initial soft layer insert
7 Inner load-transferring area
8 Outer load-transferring area
9 Further soft layer insert
11 Foundation plate
12 Granular subbase
13 Spherical bearing
MP Center
N Normal force
M Moment load
F_{M} Pair of forces
h Lever arm
a Distance of the soft layer insert 6 to the peripheral area 3
r Distance of the center MP to the peripheral area 3

1. A flat-based foundation for a structural component, the foundation comprising:
a foundation plate having an underside, an upperside, and a center;
at least one first soft layer insert on or underneath the underside of the foundation plate, wherein the at least one first soft layer insert is a non-load-transferring layer and is arranged at a distance from the center so that the foundation plate is split into at least one inner load-transferring area and at least one outer load-transferring area.

2. The foundation according to claim 1, wherein the at least one first soft layer insert is arranged around the center in the form of a ring.

3. The foundation according to claim 1, further including at least a one second soft layer insert on or underneath the underside of the foundation plate, the at least one second soft layer insert being a non-load-transferring layer and being arranged at a radial distance to the at least one first soft layer insert.

4. The foundation according to claim 3, wherein the at least one second soft layer insert is concentrically arranged inside the at least one first soft layer insert.

5. The foundation according to claim 3, wherein the at least one second soft layer insert is arranged in the form of a ring around the center.

6. The foundation according to claim 3, wherein the at least one second soft layer insert is formed as a soft layer core around the center.

7. The foundation according to claim 6, wherein the soft layer core is configured in one of a circular shape or rectangular shape.

8. The foundation according to claim 1, further including a granular subbase arranged under the foundation plate.

9. The foundation according to claim 3, further including a granular subbase arranged under the foundation plate, and wherein at least one of the at least one first soft layer insert and the at least one second soft layer insert is arranged at least partially inside the granular subbase.

10. The foundation according to claim 3, further including a granular subbase arranged under the foundation plate, and wherein at least one of the at least one first soft layer insert and the at least one second soft layer insert is arranged underneath the granular subbase.

11. The foundation according to claim 3, wherein at least one of the at least one first soft layer insert and the at least one second soft layer insert is arranged at least partially inside the foundation plate.

12. The foundation according to claim 3, wherein at least one of the at least one first soft layer insert and the at least one second soft layer insert is made of a foam.

13. The foundation according to claim 1, wherein a distance from the at least one first soft layer insert to a peripheral area of the foundation plate is between ⅓ and ½ of a distance from the center to a peripheral area.
